(19) United States
(12) Patent Application Publication
(10) Pub. No.: US 2013/0018892 A1
(43) Pub. Date: Jan. 17, 2013

(54) Visually Representing How a Sentiment Score is Computed

(71) Applicants: Maria G. Castellanos, Sunnyvale, CA (US); Perla Ruiz, Hermosillo (MX); Umeshwar Dayal, Saratoga, CA (US); Mohamed Dekhil, Santa Clara, CA (US)

(72) Inventors: Maria G. Castellanos, Sunnyvale, CA (US); Perla Ruiz, Hermosillo (MX); Umeshwar Dayal, Saratoga, CA (US); Mohamed Dekhil, Santa Clara, CA (US)

(21) Appl. No.: 13/181,059

(22) Filed: Jul. 12, 2011

(51) Int. Cl. G06F 17/30

(52) U.S. Cl. 707/748; 707/E17.014

(57) ABSTRACT

A method of visually representing how a sentiment score is computed comprises, with a sentiment scoring device, determining a number of sentiment scores for each of a number of attributes within a forum, writing a visualization file in a database based on metadata representing the sentiment scores, and outputting, to an output device, a representation of how the sentiment score was computed based on the visualization file. A system for displaying to a user how a sentiment score is computed comprises a sentiment scoring device, a forum source communicatively coupled to the sentiment scoring device, and an output device communicatively coupled to the sentiment scoring device, in which the sentiment scoring device obtains text from the forum source, determines sentiment scores for a number of attributes within the text, and outputs, to the output device, a representation of how the sentiment score was computed.

### BACKGROUND

With the increase in social networking websites, forums, blogs, and similar Internet-based forums, authors who write within these forums are more and more willing to share opinions regarding a myriad of topics. The authors' opinions include, for example, opinions about products or services sold within commerce, opinions about public figures, and opinions regarding recent events that have occurred throughout the world, among others. In one example, authors may share their opinions regarding a new device such as a camera they recently reviewed or purchased. In this example, the author may share or otherwise publish their opinion with others for various reasons including to warn others about the recently purchased camera, or to solicit advice from others who may read the forum and are able to assist the author in some manner.

Sentiment scoring of these authors' opinions allows for a reader to understand to some degree the nature of the authors' opinions, and whether their opinion is positive, negative, or neutral. However, even though these authors share their opinions on a regular or semi-regular basis, the opinions are not useful to readers of the forum or as a source of economic gain, for example, unless the opinions can be extracted and visualized for the reader in a way that allows the reader to understand how the sentiment score was obtained or calculated, and what factors played a role in determining the sentiment score of a particular author's opinion. For example, if the author expresses an opinion about a product that is positive, a reader is left to manually comb through the author's opinion to guess how that sentiment score was determined. Manually determining how a sentiment score of an author's opinion was computed equates to guesswork on the part of the reader, and takes a significant amount of time.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a system for visually representing how a sentiment score is computed, according to one example of the principles described herein.

FIG. 2 is a flowchart showing a method of visually representing how a sentiment score is computed using a sentiment scoring device, according to one example of the principles described herein.

FIG. 3 is a flowchart showing a method of visually representing how a sentiment score is computed using a sentiment scoring device, according to another example of the principles described herein.

FIG. 4 is a diagram of an attribute visualization window, according to one example of the principles described herein.

FIG. 5 is a flowchart showing a method of determining sentiment scores for attributes in a forum, according to one example of the principles described herein.

FIG. 6 is a flowchart showing a method of creating an HTML tagged sentence, according to one example of the principles described herein.

Throughout the drawings, identical reference numbers designate similar, but not necessarily identical, elements.

### DETAILED DESCRIPTION

The present systems and methods describe visually representing how a sentiment score is computed on an output device. The methods and systems enable a user to understand why a sentiment score has a given value, and allows exploration of which elements from a forum such as a review, blog, tweet, or other piece of text expressing an opinion were involved in the computation of the score and how they affected the computation. The systems and methods keep track of these elements and their metadata as the methods progress and new metadata is obtained. Using this information, the system generates an intuitive visualization of the elements contributing to a sentiment score and how they contributed to the sentiment score.

As used in the present specification and in the appended claims, the term “text” is meant to be understood broadly as any text written on a forum located or accessed via a computer network or individual computing device. Further, as used in the present specification and in the appended claims, the term “forum” is meant to be understood broadly as any medium in which text may be presented. Some examples of forums include social networking websites, product reviews, blogging websites, a microblogging service, message boards, web feeds, chat rooms, bulletin board systems, or a blog-publishing service, among others. Some specific examples of online forums include, FACEBOOK®, MYSPACE™, TWITTER™, really simple syndication (RSS) web feeds from various websites, and message boards located on various websites, among others.

Further, as used in the present specification and in the appended claims, the term “author” or similar language is meant to be understood broadly as any person who is the source of some form of literary work. In one example, an author is a person who composes text or a literary work intended for publication on a forum.

As used in the present specification and in the appended claims, the term “token” is meant to be understood broadly as any textual unit that is appropriate for indexing. In one example, tokens are the words in a language or other units of text such as, for example, a forum. Further, as used in the present specification and in the appended claims, the term “tokenizer” is meant to be understood broadly as any text segmentation device or combination of a device and software that scans text and determines if and when a series of characters can be recognized as a token.

Even still further, as used in the present specification and in the appended claims, the term “comma-separated values file,” “CSV file,” or similar language is meant to be understood broadly as any text file that contains comma-separated values. For example, a CSV file includes a number of comma separated attributes.

Even still further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

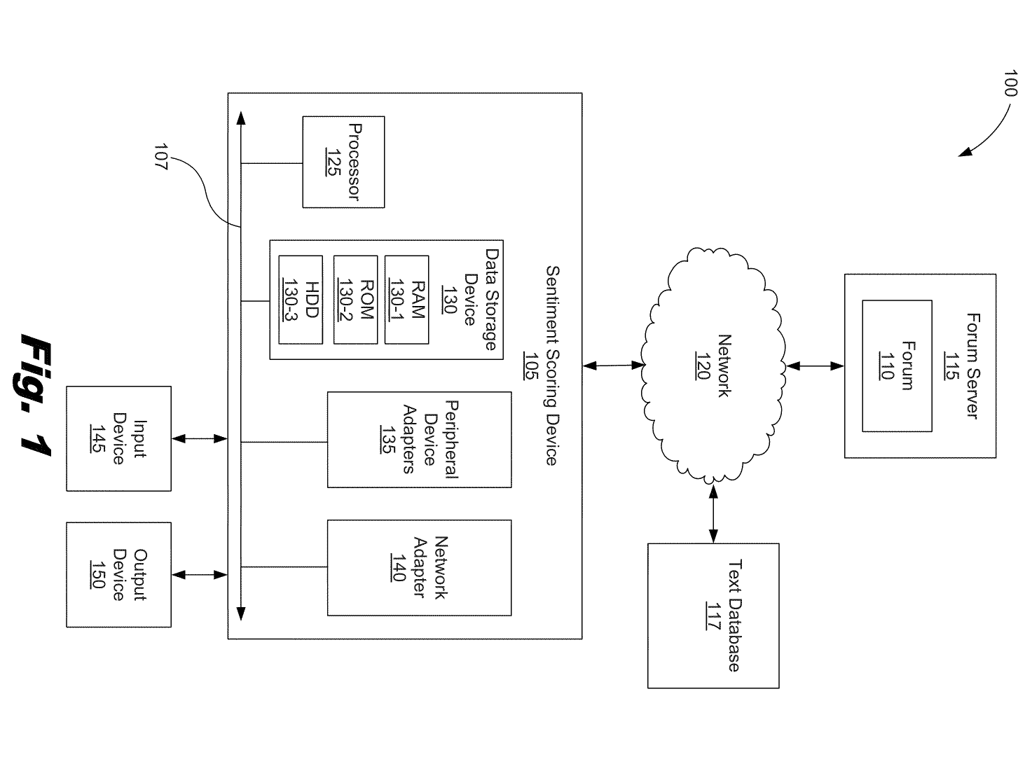

Referring now to FIG. 1, a diagram of a system (100) for visually representing how a sentiment score is computed, according to one example of the principles described herein, is depicted. The system (100) includes a sentiment scoring device (105) that has access to a forum (110) stored by a forum server (115), and a text database (117). In the present example, for the purposes of simplicity in illustration, the sentiment scoring device (105), the forum server (115), and the text database (117) are separate computing devices communicatively coupled to each other through a mutual connection to a network (120). However, the principles set forth in the present specification extend equally to any alternative configuration in which a sentiment scoring device (105) has complete access to the forum (110) and the text database (117).

As such, alternative examples within the scope of the principles of the present specification include, but are not limited to, examples in which the sentiment scoring device (105), forum server (115), and the text database (117) are implemented by the same computing device, examples in which the functionality of the sentiment scoring device (105) is implemented by multiple interconnected computers, for example, a server in a data center and a user's client machine, examples in which the sentiment scoring device (105), the forum server (115), and the text database (117) communicate directly through a bus without intermediary network devices, and examples in which the sentiment scoring device (105) has a stored local copy of the forum (110) or the text database (117) that are used to visually represent how a sentiment score is computed.

The sentiment scoring device (105) of the present example is a computing device that retrieves data associated with the forum (110) hosted by the forum server (115), and the text database (117). The sentiment scoring device (105) further determines sentiment scores for a number of attributes, stores the sentiments scores for the attributes, tracks the elements or metadata used to compute the sentiment scores and their roles in the computation, and uses these elements or metadata for visually representing how the sentiment scores are determined within the text of the forum (110). The sentiment scoring device (105) then presents the visualization of the sentiment scores to a user for processing, printing, viewing, archiving, or any other useful purpose via the application. In one example, the sentiment scoring device (105) is a desktop computer with the capability of running such an application, and displaying sentiment scores of a number of attributes to a user and the elements used to compute the scores on an output device of the desktop computer.

In another example, the sentiment scoring device (105) comprises a server communicatively coupled to a mobile computing device such as a mobile phone, personal digital assistant (PDA), or a laptop computer. The server determines the sentiment scores for the attributes, stores the sentiments scores and elements used to compute the scores, and runs an application for visually representing how the sentiment scores are determined. Mobile computing device of the present example, displays the sentiment scores of the attributes to a user on a display device of the mobile computing device. In the above examples of the sentiment scoring device (105), the visualization of the elements used in determining the sentiment scores may be displayed on the mobile computing device, transmitted to another device for further processing and analysis, stored in memory such as the data storage device (130),

Thus, the sentiment scoring device (105) may score sentiments of authors of text within the forum (110) and text database (117), and create the data structures such as matrices with the elements used in scoring the sentiments to visually depict how the sentiment scores were determined. In the present example, this is accomplished by the sentiment scoring device (105) computing sentiment scores for each attribute in a sentence contained within the text of the forum (110) of the forum server (115), and the text database (117). Illustrative processes for computing sentiment scores for each attribute, maintaining the elements within the sentences used to compute the scores as metadata in data structures, and visually representing to a user how the sentiment scores are computed are set forth in more detail below.

To achieve its desired functionality, the sentiment scoring device (105) includes various hardware components. Among these hardware components are a processor (125), a data storage device (130), peripheral device adapters (135), and a network adapter (140). These hardware components may be interconnected through the use of a number of busses and/or network connections. In one example, the processor (125), data storage device (130), peripheral device adapters (135), and a network adapter (140) are communicatively coupled via bus (107).

The processor (125) includes the hardware architecture that retrieves executable code from the data storage device (130) and executes the executable code. The executable code, when executed by the processor (125), causes the processor (125) to implement at least the functionality of extracting sentiment scores for each attribute and visually representing to a user how the sentiment scores are computed upon execution of the application according to the methods of the present specification described below. In the course of executing code, the processor (125) may receive input from and provide output to a number of the remaining hardware units.

The data storage device (130) may store data such as data or metadata representing a sentiment score, the elements (or metadata) within a sentence used to determine the sentiment score, and those elements' roles in determining the sentiment score for each attribute that is processed and produced by the processor (125) or other processing device. The data storage device (130) specifically saves data associated with the author's text including, for example, a forum's Uniform Resource Locator (URL), an author's name, address, or other identifying information, sentiment scores for the attributes found within the forum, and others portions of text within the forum an author has written. All of this data is stored in the form of a database for easy retrieval and analysis.

The data storage device (130) includes various types of memory modules, including volatile and nonvolatile memory. For example, the data storage device (130) of the present example includes Random Access Memory (RAM) (130-1), Read Only Memory (ROM) (130-2), and Hard Disk Drive (HDD) memory (130-3). Many other types of memory are available in the art, and the present specification contemplates the use of many varying type(s) of memory (130) in the data storage device (130) as may suit a particular application of the principles described herein. In certain examples, different types of memory in the data storage device (130) are used for different data storage needs. For example, in certain examples the processor (125) may boot from Read Only Memory (ROM) (130-2), maintain nonvolatile storage in the Hard Disk Drive (HDD) memory (130-3), and execute program code stored in Random Access Memory (RAM) (130-1).

Generally, the data storage device (130) may comprise a computer readable storage medium. For example, the data storage device (130) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this specification, a computer readable storage medium may be any tangible medium that can contain, or store a program for use by or in connection with an instruction execution system, apparatus, or device.

The hardware adapters (135, 140) in the sentiment scoring device (105) enable the processor (125) to interface with various other hardware elements, external and internal to the sentiment scoring device (105). For example, peripheral device adapters (135) may provide an interface to input/output devices, such as, for example, input device (145) and output device (150), a keyboard, a mouse, a display device, or external memory devices to create a user interface and/or access external sources of memory storage. As will be discussed below, a number of output devices (150) may be provided to allow a user to interact with the sentiment scoring device (105), select an attribute from among a number of attributes displayed on the output device (150), and obtain a visual representation of how a sentiment score is calculated for that attribute. For example, the output device (150) may be a display for displaying a user interface for the sentiment scoring device (105). In another example, the output device (150) may be a printer for printing information processed by the sentiment scoring device (105). In still another example, the output device (150) may be an external data storage device for storing data associated with a visual representation of how a sentiment score is calculated.

The network adapter (140) provides an interface to the network (120), thereby enabling the transmission of data to and receipt of data from other devices on the network (120), including the forum server (115) and text database (117).

The text database (117) may be any data storage device that stores portions of text of a number of forums (110). Generally, the text database (117) may comprise a computer readable storage medium. For example, the text database (117) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The text database (117) may, in place of or in conjunction with the sentiment scoring device (105), collect and save data associated with an author's text found within a forum (110).

The network (120) comprises two or more computing devices communicatively coupled. For example, the network (120) may include a local area network (LAN), a wide area network (WAN), a virtual private network (VPN), and the Internet, among others.

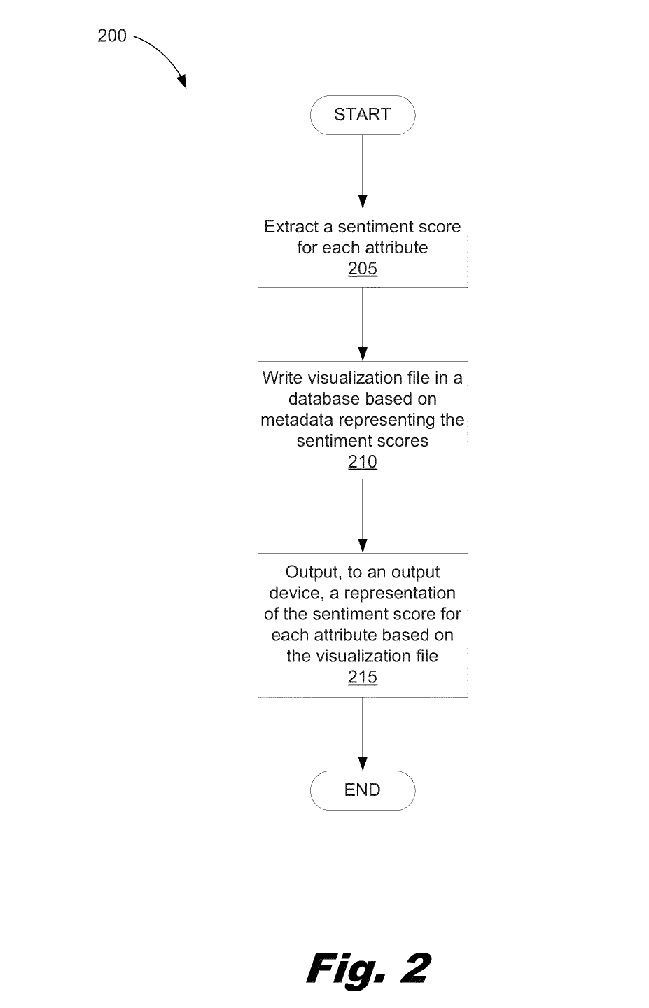

FIG. 2 is a flowchart showing a method (200) of visually representing how a sentiment score is computed using a sentiment scoring device (105), according to one example of the principles described herein. The method (200) begins by extracting (block 205) a number of sentiment scores for each of a number of attributes within the text of a forum. In one example, the forum is the forum (110) located on the forum server (115). In another example, the forum is any text stored in the text database (117). In yet another example, the forum is any medium in which text may is presented.

In one example, the sentiment scoring device (105) analyzes the text of the forum (110, 117) to extract (block 205) the sentiment score for each occurrence of an attribute within any sentence. For example, in the sentence “[t]he battery of the laptop runs out fast,” “battery” is an attribute of the entity “laptop.” The method by which the sentiment scoring device (105) extracts (block 205) a sentiment score may include any method as long as it records or otherwise keeps track of the metadata used to determine the sentiment scores. In one example, the sentiment scoring device (105) stores the elements used in the determination of the sentiment scores in data structures such as matrices. In one example, these matrices are stored in the data storage device (130). These data structures are interpreted by the sentiment scoring device to produce, for example, an html page that displays to a user how the sentiment scores were determined.

After extracting (block 205) the sentiment scores, the sentiment scoring device (105) writes (block 210) a visualization file in a database based on metadata representing the sentiment scores. In one example, the sentiment scoring device (105) stores the visualization file to the data storage device (130). In another example, the sentiment scoring device (105) stores the visualization file to a storage device external to the sentiment scoring device (105) such as, for example, the text database (117).

The sentiment scoring device (105) then outputs (block 215), to an output device, a representation of the sentiment score for each attribute based on the visualization file. In one example, the output device is output device (150). As described above, output device (150) is, for example, a display for displaying a user interface including the representation of the sentiment score for each attribute. In another example, the output device (150) is a printer for printing information including the representation of the sentiment score for each attribute.

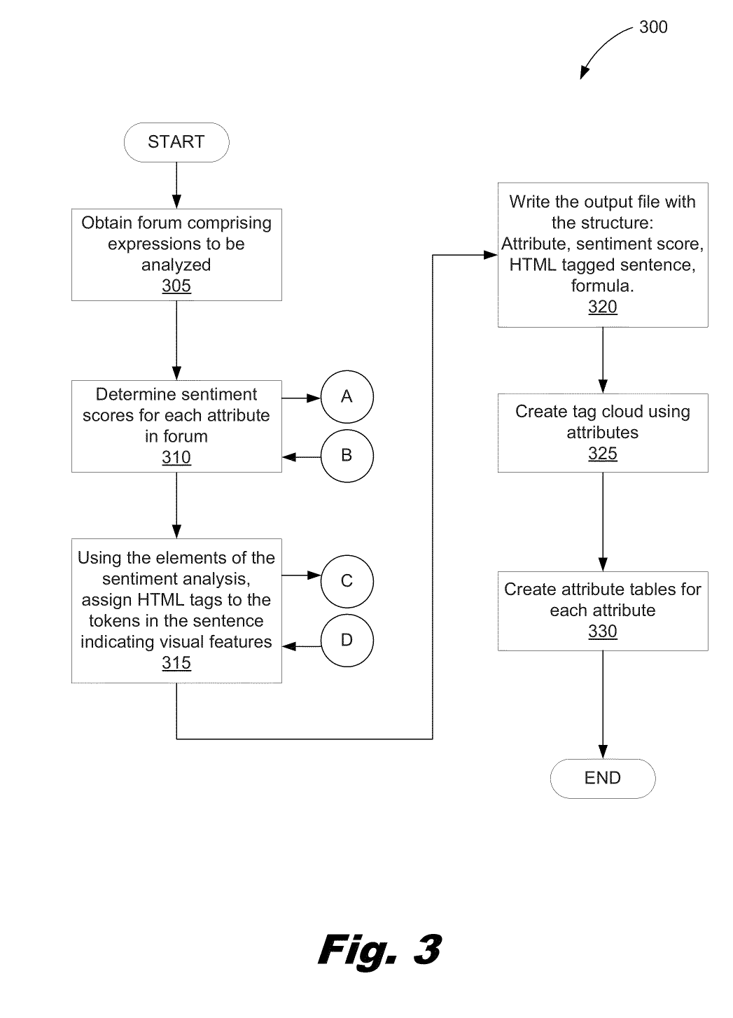

FIG. 3 is a flowchart showing a method (300) of visually representing how a sentiment score is computed using a sentiment scoring device (105), according to another example of the principles described herein. The method (300) of FIG. 3 begins by obtaining (block 305) a forum comprising expressions to be analyzed. In one example, the forum includes a comma-separated values (CSV) file obtained from, for example, the text database (117). In another example, the forum includes text obtained from the forum (110) located on the forum server (115), and accessible to the sentiment scoring device (105) via network (120).

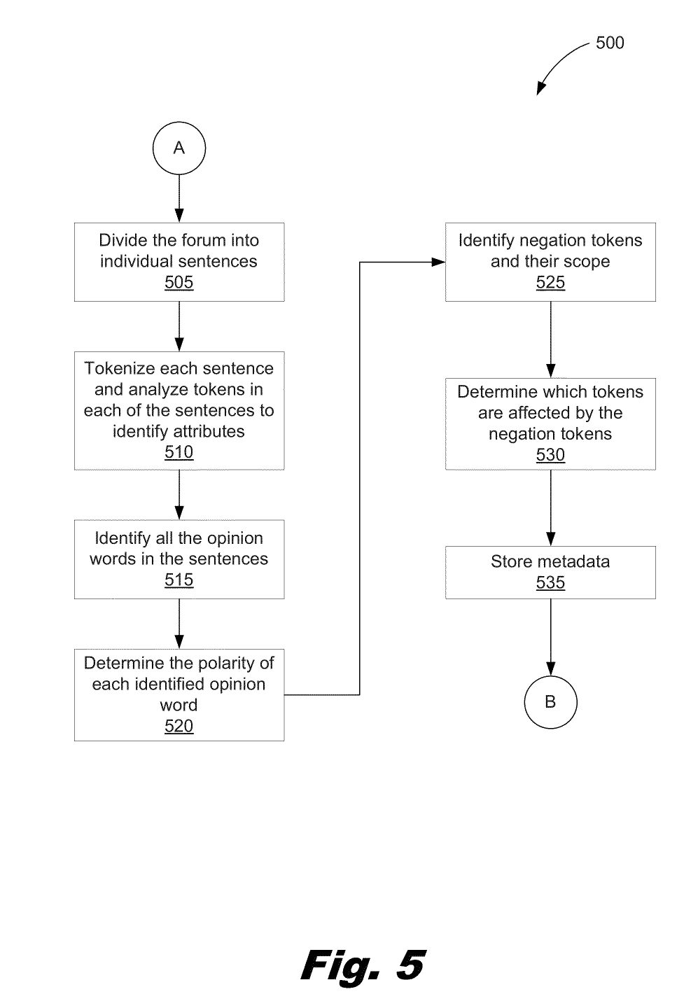

Next, the method (300) of FIG. 3 continues by determining (block 310) the sentiment scores for each attribute in the forum. The determination (block 310) of sentiment scores for each attribute may be performed using any method. One example of such a method is described in FIG. 5. FIG. 5 is a flowchart showing a method of determining sentiment scores for attributes in a forum, according to one example of the principles described herein. Following indicator “A” from FIG. 3 to FIG. 5, the sentiment scoring device (105) determines (block 310) the sentiment scores for the attributes by first dividing (block 505) the forum into individual sentences. In one example, the sentiment scoring device (105) detects the presence of sentence terminators such as, for example, periods, exclamation marks, and question marks, among others, used to divide the text of the forum (110, 117)) into sentences.

The sentiment scoring device (105) then tokenizes (block 510) each sentence, and analyzes, one by one, the tokens in each of the sentences to identify attributes. Then, continuing with method (500), the sentiment scoring device (105) determines (block 310) the sentiment score of each attribute by identifying (block 515) all the opinion words in the sentences such as, for example, “expensive,” “nice,” “fast,” or other opinion words. In one example, the sentiment scoring device (105) identifies (block 515) all the opinion words within a context window of a sentence including a number n of tokens before an attribute token and a number m of tokens after the an attribute token. Thus, in this example, the context window from which the sentiment scoring device (105) identifies the opinion words of a sentence may be expressed as follows:

<starting token> . . . <Word 1><Word 2><Word 3><Word 4><Word 5><Word 6><Word 7><Word 8><Word 9><Word 10><Word n><ATTRIBUTE><Word 1><Word 2><Word 3><Word 4><Word 5><Word 6><Word 7><Word 8><Word 9><Word 10><Word m> . . . <ending token>

The sentiment scoring device (105) then determines (block 520) if each identified opinion word has a positive, negative, or neutral polarity. Examples of opinion words that have a positive polarity include “nice,” “good,” and “pretty,” among many others. Examples of opinion words that have a negative polarity include “worst,” “bad,” and “ugly,” among many others. Examples of opinion words that have a neutral polarity include “black,” “digital,” and “quality,” among many others.

After determining (block 520) a polarity for each opinion word, the sentiment scoring device (105) identifies (block 525) negation tokens and their scope. Negation within a sentence reverses the polarity of opinion words. Examples of negation tokens include “not,” and “isn't,” among many others. When the sentiment scoring device (105) identifies the opinion words' scope, it determines (block 530) which tokens are affected by the negation tokens. An example in natural language where a negation token causes a reversal of polarity of an opinion word may be in the expression “it isn't bad.” Here, the token “bad” has a negative polarity, but the negation “isn't” reverses the polarity so that “bad” now evokes a positive polarity.

In this manner as the method (300, 500) progresses, more and more metadata about each token is obtained. A list of metadata that is obtained includes, for example:
1) forum id: the identifier of the forum being analyzed
2) sentence id: the identifier of the sentence in the forum
3) token id: the identifier of the token within a forum or a sentence
4) token: the token itself, that is, its surface form
5) attribute: a flag indicating whether the token is an attribute or not
6) opinion word: a flag indicating whether the token is an opinion word or not
7) negation word: a flag indicating whether the token is a negation word or not
8) polarity: a flag that applies to opinion word tokens and indicates if a particular polarity is positive, negative, or neutral
9) negated: a flag that applies to opinion word tokens and indicates whether it is affected by a negation or not
10) score: a flag that applies to tokens that are attributes and contains the value of the sentiment score
   This metadata is then stored (block 535) in memory to be available for computing the sentiment score of each attribute in each sentence using a scoring formula by following indicator “B” from FIG. 5 to FIG. 3. In one example, the metadata is stored in the data storage device (130) of the sentiment scoring device (105). Further, as will be discussed in more detail below, the sentiment scoring device (105) stores the metadata about the tokens in each sentence into a number of different matrices. These matrices are utilized in generating (block 320) the output file “VISUALIZE_FILE,” as will be discussed in more detail below.

The sentiment score for each attribute is determined (block 310) by the sentiment scoring device (105) using, in one example, a weighted sum of the opinion words in a context window where the weight of each opinion word is inversely proportional to its distance from the attribute word. In this example, the weighted sum utilizes the polarity value of every opinion word where positive opinion words are given a +1 value, negative opinion words are given a −1 value, and neutral opinion words are given a value of 0. The sentiment score of an opinion word is determined using the following equation:

$$( ( \frac{1}{distance from attribute} ) * ( polarity of opinion word ) ) \qquad Eq . 1$$

Equation 1 is applied to each opinion word within the sentence being analyzed, and their sum is the sentiment score of that sentence.

Further, in one example, the resulting value is rounded to 1 if it is greater than 0, or −1 if it is less than 0. For example, the score for the attribute word “camera” in the sentence, “[t]his ugly looking camera contains good features but it is too slow,” is calculated as follows:

((½)*(−1))+((½)*(+1))+(( 1/7)*(−1))=−0.14

In this example, the attribute word “camera” has three opinion words in its context window. These opinion words are as follows: the word “ugly” with negative polarity (−1) at a distance of 2 from the attribute word “camera”; the word “good” with positive polarity (+1) at a distance of 2 from the attribute word “camera”; and the word “slow” with negative polarity (−1) at distance 7 from the attribute word “camera.” The sentiment score of the above example sentence of −0.14 is rounded to −1 since it is less than 0. In this manner, the sentiment scores for each attribute in the forum as well as each sentence in the forum is determined (block 310).

The sentiment scoring device (105), using the sentiment scores and the elements (or metadata) obtained from block 310, assigns (block 315) hyper text markup language (HTML) tags to the tokens in the sentences indicating visual features of the tokens within the sentences, as will be discussed in more detail below. The sentiment scoring device (105) then writes (block 320) to the data storage device (130) a visualization file such as, for example, “VISUALIZE_FILE.” This visualization file is used for visualization of, via the output device (150), the results of the sentiment analysis and other information regarding the computation of the sentiment scores. Thus, for each occurrence of an attribute, the sentiment scoring device (105) creates a record with the following CSV file format:

Attribute, sentiment score, sentence with html tags, instantiated scoring formula

The “sentence with html tags” referred to in the above file format contains the elements that will provide the visual representation of the rationale for the sentiment scores. These elements are determined based on the metadata included in the above list of ten types of metadata created during sentiment analysis and scoring, and are stored in the number of different matrices referred to above and described in more detail below. In one example, the file contains all the information that is used to demonstrate visually to the user how a particular sentiment score was determined. In one example, this information is presented to a user with visual features. These visual features provide to the user the ability to quickly and easily understand the displayed information, and how a sentiment score is determined. For example, the information is formatted using color, underlining, or other visual features that are associated with those tokens that influenced the calculation of the sentiment score. Thus, the visual features are determined according to the metadata of the influential tokens in such a way that they facilitate the understanding of how a sentiment score was computed. In this example, HTML elements are assigned (block 315) to indicate, for each token in the tagged expression, the tokens' color, if the tokens is underlined, or if the tokens has other forms of visual features.

The above-described visualization file written in block 320 is the input for the visualization of the results of the sentiment scoring determined at block 310. When the visualization starts, a representation of the attributes and their overall sentiment scores (per attribute) as computed from the average of the individual sentiment scores of each occurrence of an attribute is presented to the user. In one example, the representation is presented to the user via a user interface displayed on the output device (150).

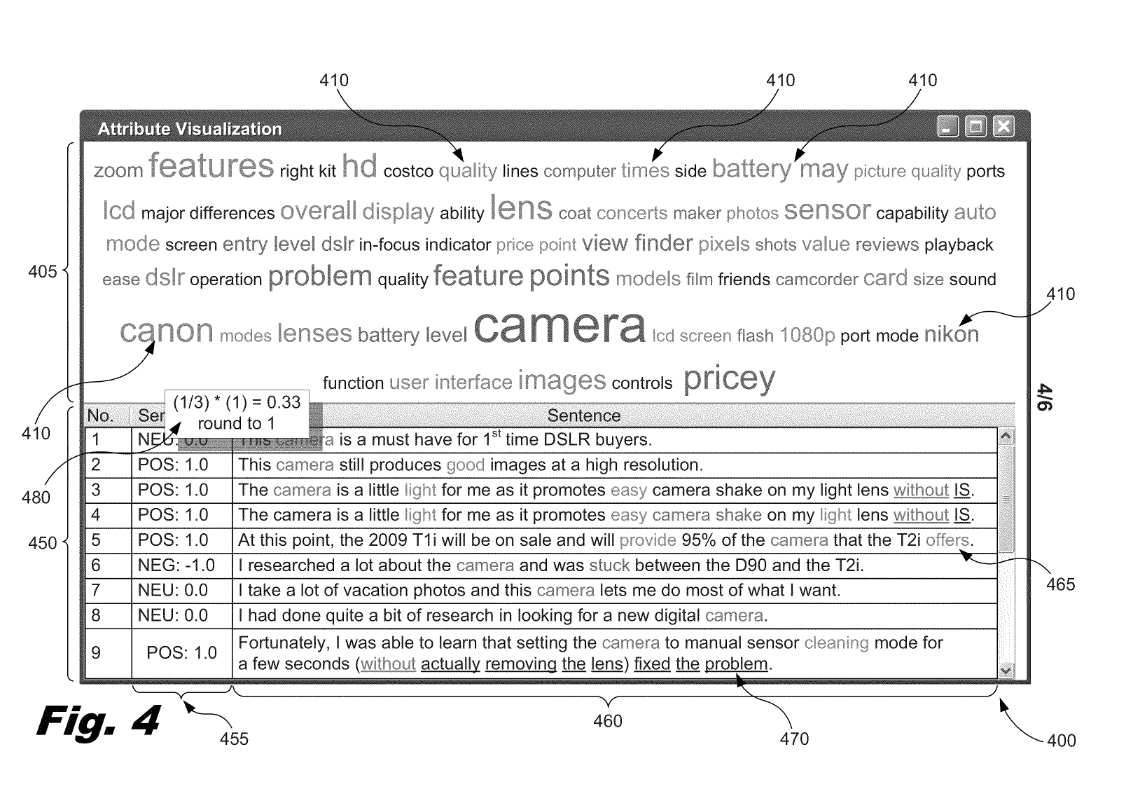

In one example, the representation is a list of attribute and overall score pairs expressed in, for example, a table format. In another example as depicted in FIG. 4 and block 325 of FIG. 3, the representation includes a tag cloud (405) where the size and color of each tagged attribute (410) depends on its frequency and overall sentiment score, respectively. FIG. 4 is a diagram of an attribute visualization window (400), according to one example of the principles described herein. According to the overall sentiment scores, the user may be interested in exploring some of the sentiment scores associated with a particular attribute (410). The attribute visualization window (400) allows the user to select one of the attributes (410). In one example, selection of an attribute is performed by clicking on a tagged attribute (410) in the tag cloud (405). Upon selection of an attribute (410), a corresponding attribute table (450) is displayed within the attribute visualization window (400). Referring to FIG. 3, the attribute tables are created (block 330) for each attribute.

The attribute table (450) includes one row for each occurrence of the attribute (410). Each row contains the individual sentiment score (455) for the occurrence of the attribute (410) in a sentence. Each row also includes the sentence (460) in which the attribute (410) appears. The sentence (460) includes visual features corresponding to the HTML tagged expressions described above. That is, the visualization window (400) highlights the attribute (410) in one color and the tokens that influenced the sentiment score within the sentences (460) with a color (465) corresponding to their polarity. Further, the visualization window (400) underlines (470) all the tokens affected by a negation so that the user understands when a polarity is reversed. In one example, the user can select an option on the attribute table (450) to display the sentiment scoring formula (480) instantiated with the polarity values of the tokens that influenced the computation of the sentiment score. In this example, the selection may be performed by scrolling over a portion of the attribute table (450) with a cursor directed by an input device (145) such as, for example, a mouse.

With the colored visualization of the sentences (460) in the attribute table (450) along with the instantiated sentiment scoring formula (480), the user can easily understand how a sentiment score was obtained. Further, the attribute visualization window (400) also facilitates the validation and debugging of the sentiment analysis methods by assisting a user or computer programmer to find mistakes in how the sentiment scoring device (105) determined the sentiment scores for a number of attributes in the forum.

As described above, the instrumented sentiment scoring device (105) stores the metadata about the tokens in each sentence into different matrices. As discussed above, the metadata is the metadata included in the above list of ten types of metadata created during sentiment analysis and scoring, as described above. These matrices are utilized in generating the output file “VISUALIZE_FILE,” mentioned above. A first matrix, matrix_1, is implemented as an array of strings, and includes all the sentences from the forum. Each sentence is an element of matrix_1.

The next matrix, matrix_2, is created for each sentence (460), and includes the tokens for each individual sentence, one token per element of matrix_2. A number of sentences within the forum may each have different lengths equating to a different number of tokens within the sentence. Therefore, the number of columns in matrix_2 varies per row.

For each of matrix_2's tokens, there are three corresponding matrices of Boolean values with one to one correspondence between their elements. Matrix_3 indicates if the token in a particular corresponding position within matrix_2 is an attribute. Matrix_4 indicates if the token in a particular corresponding position within matrix_2 has positive polarity, a negative polarity, or a neutral polarity. Matrix_5 indicates if a particular token's polarity in a particular corresponding position within matrix_2 is reversed by a negation word.

Thus, writing (block 320) the output file “VISUALIZE_FILE,” starts by the processor (125) of the sentiment scoring device (105) iterating on the rows of sentence matrix, matrix_1. For each row in matrix_1, the processor (125) of the sentiment scoring device (105) then checks against the first Boolean matrix, matrix_3, to see if there are flags indicating that there are attributes in the sentence. For each attribute found in matrix_3, a record in the output file, “VISUALIZE_FILE” is created.

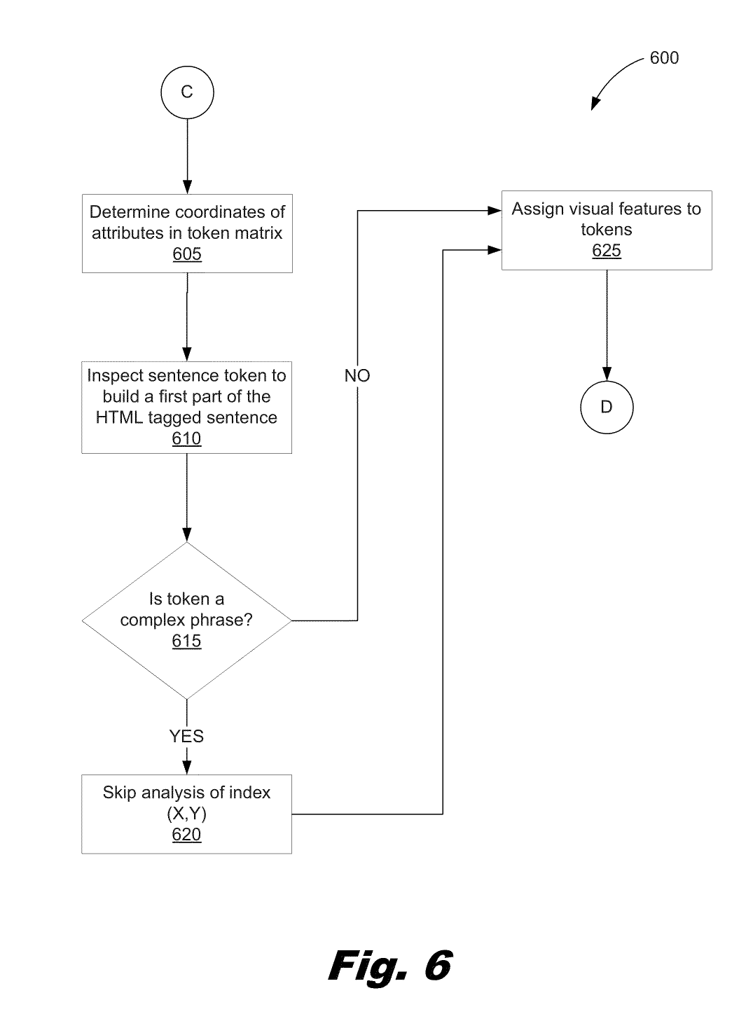

Now that a process of utilizing the matrices in generating the output file “VISUALIZE_FILE,” has been discussed above, the process by which the matrices are utilized to create a record of the HTML tagged sentences after the HTML tags are assigned (block 315) to the tokens in the sentences will now be described in connection with FIG. 6. FIG. 6 is a flowchart showing a method of creating an HTML tagged sentence, according to one example of the principles described herein. The method (600) will be described by following indicator “C” from FIG. 3 to FIG. 6.

The method (600) of FIG. 6 begins by determining (605) coordinates of the attributes in the token matrix, matrix_2. In one example, the index of a row in the matrix with the sentences is called Xᵢ, and the index of the token flagged as an attribute is called Yᵢ. These indexes are the coordinates of the attribute in the token matrix, matrix_2. Next, the sentiment scoring device (105) inspects (block 610) the sentence tokens backwards to build the first part of the HTML tagged sentence from index Y₋₁ to index Yₙ. In one example, the first part of the HTML tagged sentence is a string variable denoted as “sentenceFirstPart.”

For each token inspected (block 610) by the sentiment scoring device (105), it is determined (block 615) if the token is a complex phrase. A complex phrase is a token that comprises more than one word. In one example, this is done by checking a sixth matrix, matrix_6. Matrix_6 includes the same dimensions as the token matrix, matrix_2, and contains a Boolean value for the element with the same indexes indicating if the corresponding token is complex or not. If a token is a complex phrase, there are additional elements corresponding to the token in the matrices. In addition to the elements corresponding to its component tokens, the token matrix, matrix_2, contains the complex phrase as well. That is, if the token is complex and contains a K number of words, the matrix will include each of the K single words and the composition of the K number words. For example, for the complex phrase “laserjet printer,” matrix_2 will contain the following tokens:

[laserjet][printer][laserjet printer]

If the sentiment scoring device (105) determines the token is a complex phrase (block 615, Determination YES) for a token in position (X, Y), then the index (X, Y) skips a number of positions equal to the number of single words of the complex phrase (block 620) so that the visualization application of the sentiment scoring device (105) does not redundantly check the token's component tokens to see if they are opinion words. If, however, the sentiment scoring device (105) determines the token is not a complex phrase (block 615, Determination NO), then the method (600) continues by the sentiment scoring device (105) assigning (block 625) visual features to the tokens based on the tokens' polarity defined in matrix_4.

At block 625, matrix_4 defines a token as having one of the values +1, −1 or 0 depending on the polarity, or absence of polarity of the token. If the value defined in matrix_4 is equal to +1, the token is given a visual feature that indicates the positive polarity of the token. In one example, a token with a positive polarity is given a text color of green. Further, if the value defined in matrix_4 is equal to −1, the token is given a visual feature that indicates the negative polarity of the token. In one example, a token with a negative polarity is given a text color of red. Still further, if the value defined in matrix_4 is equal to 0, indicating a neutral polarity, the token is given a visual feature that indicates the neutrality of the token. In one example, a token with a neutral polarity is not given a visual feature. In another example, a token with a neutral polarity is given a text color of black.

Further, if, according to matrix_5, the token is affected by a negation word, then the token is given a visual feature that indicates that the token is affected by a negation word. In one example, those tokens affected by a negation word are underlined. The above visual features assigned (block 625) to the tokens are translated to the HTML tags to build a string. Several examples follow:
1) For a token with polarity value of +1 and a flag indicating that it is affected by a negation, the following string is created:
   sentenceFirstPart=“<font color=‘green’><u>”+sentenceArray[Y]+“</u></font>”
2) For a word with a negative opinion −1 and a flag indicating that is affected by a negation, the following string is created:
   sentenceFirstPart=“<font color=‘red’><u>”+sentenceArray[Y]+“</u></font>”
3) For a token with polarity value of +1 and with flag indicating that it is not affected by a negation, the following string is created:
   sentenceFirstPart=“<font color=‘green’>”+sentenceArray[Y]+“</font>”

In one example, if the word has a polarity value equal to 0, and is not an opinion word, then the word is neutral. As described above, in one example, the token associated with the neutral word is not colored with an HTML tag. If the token is a negation word according to another matrix, matrix_7, then the token is given a visual feature that indicates the token is a negation word. In one example, a token that is determined to be a negation word is given a text color of pink. Further, if the negation word is affected by another negation word, then the token defined as a negation word will also be underlined. An example of this situations is as follows:
4) sentenceFirstPart=“<font color=‘#FF00CC’><u>”+sentenceArray[Y]+“</u></font>”

If the token does not contain any relevant feature that makes it have influence in the sentiment score of the attribute, that token will have the following string:
5) sentenceFirstPart=sentenceArray[Y]

This process is repeated until the index Yₙ of the sentence is reached. As tokens are inspected, the first part of the sentence as it will be displayed with the HTML tags is built by concatenating the new string. The first part of the sentence is built in the following way:
6) sentenceFirstPart=“<font color=‘red’><u>”+sentenceArray[Y]+“</u></font>”+sentenceFirstPart;
   This is because for the first part of the sentence, the sentiment scoring device (105) is inspecting (block 610) the tokens backwards. When the index Yₙ is reached and the string for its token has been added to the string corresponding to the first part of the sentence, the sentenceFirstPart string is complete. Thus, the sentenceFirstPart of the string is initialized with all the tokens that appear in the sentence before the beginning of the attribute's context window from index Y₀ to Yₙ. This is done by adding the token strings one by one as follows:
7) sentenceFirstPart=sentenceArray[Y]

Once the string is completed, the first part of the HTML tagged sentence, sentenceHTML, that has the visualization features embedded in the HTML tags is ready to be copied to the sentenceHTML string that will contain the whole html tagged sentence:
8) sentenceHTML=sentenceFirstPart;

The second part of the sentenceHTML is the attribute that has been inspected. The second part of the sentenceHTML is concatenated to the sentenceHTML string with a visual feature indicating that it is the attribute. In one example, the visual feature of the attribute is a text color of blue to distinguish it as an attribute. The attribute is also checked against its corresponding element in the negations matrix, matrix_7, to determine if it is affected by negation. If the attribute is affected by a negation, the attribute will also have the underlining feature. For example:
9) If the attribute is affected by a negation the string will be:
   sentenceHTML=sentenceHTML+“<font color=‘blue’><u>”+sentenceArray[Y]+“</u></font>”;
10) If the attribute is not affected by negation the string will be:
   sentenceHTML=sentenceHTML+“<font color=‘blue’>”+sentenceArray[Y]+“</font>”

Then, the third part of the sentence is built by inspecting each of the next m tokens in the context window of the attribute, that is, from index Y₁ to Yₘ. The process of inspecting the features of each element in the third part of the sentence is the same as that applied for the first part of the sentence, except the inspection of the third part of the sentence is performed forwards to build the last part of the sentence. In this manner, the third part of the sentence is denoted as a variable string sentenceLastPart, and is concatenated at the end in contrast to being concatenated at the beginning

An example of the concatenation of a token with polarity of +1 according to the value of the element with the same index in matrix_4 and affected by negation according to the flag of the element with the same index in matrix_7, is the following:
11) sentenceLastPart=sentenceLastPart+“<font color=‘green’><u>”+sentenceArray[Y]+“</u></font>”

When the sentiment scoring device (105) reaches the last index of the attribute's context at Yₘ, and finishes the inspection of the corresponding token, the string with the last part of the sentence is completed with the rest of the token in the sentence. In this situation, the inspection (block 610) has run from index Yₘ to the end, and it is concatenated to the rest of the sentenceHTML as follows:
12) sentenceHTML=sentenceHTML+sentenceLastPart;

The sentence annotated with HTML tags is written as the field “sentence with html tags” within the record for that attribute in the VISUALIZE_FILE so that when the attribute is visualized, the sentence is displayed with the visualization features corresponding to the influence of its tokens. The complete record is written (block 320) with the following format as described above:

Attribute, sentiment score, sentence with html tags, instantiated scoring formula

Turning again to FIG. 3, the method (300) continues by creating (block 325), with the visualization application executed by the processor (125) of the sentiment scoring device (105), some representation of the attributes and their overall scores, for example, a tag cloud (405) based on the information about the attributes obtained at block 310. The visualization application executed by the processor (125) of the sentiment scoring device (105) displays the tag cloud (405) in the attribute visualization window (400). Further, the attribute visualization window (400) is displayed on the output device (150). Next, the sentiment scoring device (105) also creates (block 330) attribute tables for each attribute of interest, as described above.

The methods described above may be implemented in connection with forums of any language. Because the grammatical and syntax rules differ between languages, the above methods are adapted to the rules of the language of the forum.

Further, the methods described above may be utilized for a number of economic reasons. In one example, the above methods are utilized to determine an author's opinion regarding a product, and apply that opinion for market analysis purposes.

The methods described above may be accomplished in conjunction with a computer program product comprising a computer readable medium having computer usable program code embodied therewith that, when executed by a processor, performs the above methods. Specifically, the computer program product identifies a number of statements of intention within an online forum, and extracts a number of attributes from the statements of intention.

The specification and figures describe a system and method of visually representing how a sentiment score is computed. This method may have a number of advantages, including: 1) providing a way for a user to easily understand how a sentiment value was obtained; 2) facilitates the validation and debugging of the sentiment analysis methods by assisting in finding mistakes in the methods; and 3) provides an easy way for third parties to gather knowledge about an author's opinions and their details including what aspects (i.e., attributes and the opinion words associated to them) have determined these opinions, among other advantages.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of visually representing how a sentiment score is computed comprising:
with a sentiment scoring device, determining a number of sentiment scores for each of a number of attributes within a forum;
writing a visualization file in a database based on metadata representing the sentiment scores; and
outputting, to an output device, a representation of how the sentiment score was computed based on the visualization file.

2. The method of claim 1, in which the metadata representing the sentiment scores comprises a number of elements within a portion of text and their roles in the score computation, and in which writing a visualization file in a database based on metadata representing the sentiment scores comprises storing the elements in a number of data structures corresponding to the elements' roles in determining the sentiment scores.

3. The method of claim 2, in which the metadata comprises an identifier of the forum, an identifier of the sentence in the forum, an identifier of a token within the forum, a token, a flag indicating whether the token is an attribute or not, a flag indicating whether the token is an opinion word or not, a flag indicating whether the token is a negation word or not, a flag that indicates the polarity of an element if it is an opinion word, a flag that indicates whether an opinion word is affected by a negation or not, a value of the sentiment score if the token is an attribute, or combinations thereof.

4. The method of claim 1, in which outputting, to an output device, a representation of how the sentiment score was computed based on the visualization file comprises:
creating an attribute visualization window, and
with the output device, displaying the attribute visualization window.

5. The method of claim 4, in which the attribute visualization window comprises:
a number of tokens representing the distinct attributes, their frequencies, and overall scores; and
a number of attribute tables for each token within the tag cloud.

6. The method of claim 5, further comprising:
displaying a number of rows in each attribute table, each row representing an occurrence of the attribute within a sentence of the forum;
within each row, presenting a sentiment score for the occurrence of the attribute within the sentence; and
within each row, presenting the sentence in which the attribute appears.

7. The method of claim 6, further comprising displaying, for each row, a sentiment scoring formula defining the formula used to compute the sentiment score for the attribute within a sentence.

8. The method of claim 1, in which determining a number of sentiment scores for each of a number of attributes within a forum comprises:
dividing the forum into a number of individual sentences;
tokenizing each sentence and identifying each of the tokenized sentences to identify attributes;
identifying the opinion words in the sentences;
determining the polarity of each identified opinion word;
identifying negation words; and
determining which tokens are affected by the negation words.

9. The method of claim 1, in which writing a visualization file in a database based on metadata representing the sentiment scores comprises:
writing the visualization file as a comma-separated values (CSV) file,
in which the comma-separated values of the CSV file comprise an attribute, a sentiment score, a sentence with html tags, and an instantiated scoring formula.

10. A system for displaying to a user how a sentiment score is computed, comprising:
a sentiment scoring device;
a forum source communicatively coupled to the sentiment scoring device; and
an output device communicatively coupled to the sentiment scoring device,
in which the sentiment scoring device obtains text from the forum source, determines sentiment scores for a number of attributes within the text, and outputs, to the output device, a representation of how the sentiment score was computed.

11. The system of claim 10, in which the sentiment scoring device causes the output device to display an attribute visualization window, the attribute visualization window comprising:
a tag cloud of a number of tokens representing the attributes;
a number of attribute tables for each attribute within the tag cloud; and
a sentiment scoring formula for each attribute within the tag cloud.

12. The system of claim 10, in which the forum source is a forum located on a forum server, and accessible to the sentiment scoring device via a network.

13. The system of claim 10, in which the forum source is a text database accessible to the sentiment scoring device via a network.

14. The system of claim 10, in which the output device is a display device or a printer.

15. The system of claim 10, in which the sentiment scoring device is a desktop computer, a laptop computer, a mobile phone, or a personal digital assistant.

16. A computer program product for displaying how a sentiment score is computed, the computer program product comprising:
a computer readable storage medium comprising computer usable program code embodied therewith, the computer usable program code comprising:
computer usable program code that, when executed by a processor, causes a display device to display an attribute visualization window on an output device;
computer usable program code that, when executed by a processor, causes a display device to display a tag cloud of a number of tokens representing a number of attributes within the attribute visualization window; and
computer usable program code that, when executed by a processor, causes a display device to display a number of attribute tables for each token within the tag cloud.

17. The computer program product of claim 16, further comprising:
computer usable program code that, when executed by a processor, displays the tokens representing the attributes within the tag cloud at different sizes based on the frequency of appearance of the attributes associated with the tokens within a forum from which the attributes are analyzed.

18. The computer program product of claim 16, further comprising: computer usable program code that, when executed by a processor, displays the tokens representing the attributes within the tag cloud and the attribute tables with different visual features based on the polarity of the attributes.

19. The computer program product of claim 16, further comprising: computer usable program code that, when executed by a processor, displays the tokens representing the attributes within the tag cloud and the attribute tables with different visual features if the attribute is a negation word.

20. The computer program product of claim 16, further comprising: computer usable program code that, when executed by a processor, displays a sentiment scoring formula for each attribute within the tag cloud.
